(19) United States
(12) Patent Application Publication
(10) Pub. No.: US 2015/0186109 A1
(43) Pub. Date: Jul. 2, 2015

(54) SPATIAL AUDIO USER INTERFACE APPARATUS

(71) Applicants: Roope Olavi Järvinen, Lempaala (FI); Kemal Ugur, Istanbul (FI); Mikko Tammi, Tampere (FI)

(72) Inventors: Roope Olavi Järvinen, Lempaala (FI); Kemal Ugur, Istanbul (FI); Mikko Tammi, Tampere (FI)

(73) Assignee: Nokia Corporation, Espoo (FI)

(21) Appl. No.: 14/416,165

(22) PCT Filed: Aug. 10, 2012
(86) PCT No.: PCT/IB2012/054089

§ 371 Date: Jan. 21, 2015

(51) Int. Cl. G06F 3/16; G06F 3/0484

(52) U.S. Cl. CPC G06F 3/167; G06F 3/04842

(57) ABSTRACT

An apparatus comprising: an input configured to receive at least one detected acoustic signal from one or more sound sources; a sound direction determiner configured to determine one or more directions associated with the one or more sound sources based on the detected at least one acoustic signal; and a user interface input generator configured to generate at least one user interface input based on the one or more directions, wherein the user interface input is configured to control the apparatus operation.

### FIELD

The present application relates to spatial audio user interface apparatus and processing of audio signals. The invention further relates to, but is not limited to, apparatus implementing spatial audio capture and processing audio signals in mobile devices.

### BACKGROUND

Electronic apparatus user interface design is a field which has been greatly researched over many years. The success of a product can often be attributed to the ease of use without compromising the richness of control over the apparatus. Current favoured user interfaces are touch screen user inputs able to detect the touch of a user on the screen and from this touch or touch parameter control the device in some manner and voice control where the user's spoken voice is analysed to control the functionality of the apparatus.

With respect to touch screen user interface inputs implemented on portable devices, the designers are currently attempting to squeeze as much display space as possible from the physical dimensions of the device by limiting other inputs. This is a natural progression from the requirement to allow the user to have the largest possible screen but prevent the physical dimensions of the apparatus from being too large to fit in pockets or carry conveniently.

This limiting other inputs has required user interface inputs such buttons, switches, dials and keys being replaced by virtual keys, switches, dials (in other words a representation of the input displayed on the screen and interacted with using the touch interface).

Implementing virtual inputs however can reduce the amount of display area available to display information.

### SUMMARY

Aspects of this application thus provide an audio recording or capture process whereby both recording apparatus and listening apparatus orientation can be compensated for and stabilised.

According to a first aspect there is provided an apparatus comprising: an input configured to receive at least one detected acoustic signal from one or more sound sources; a sound direction determiner configured to determine one or more directions associated with the one or more sound sources based on the detected at least one acoustic signal; and a user interface input generator configured to generate at least one user interface input based on the one or more directions, wherein the user interface input is configured to control the apparatus operation.

The apparatus may further comprise a display module configured to display and/or receive at least one information of at least one user interface for the apparatus operation.

The apparatus may further comprise two or more microphones configured to detect at least one acoustic signal from one or more sound sources.

The sound direction determiner may be configured to determine the one or more directions associated with the one or more sound sources based on the detected at least one acoustic signal relative to the apparatus.

The input configured to receive at least one detected acoustic signal may comprise at least a first audio signal input from a first microphone and at least a second audio signal input from a second microphone.

The sound direction determiner may be configured to: identify at least one common audio signal component within the at least one first audio signal and the at least one second audio signal; and determine a difference between the at least one common component such that the difference defines the one or more directions.

The apparatus may further comprise a sound amplitude determiner configured to determine at least one sound amplitude associated with the one or more sound sources; and the user interface input generator may be configured to generate at least one user interface input based on the one or more amplitude associated with the one or more sound sources, such that the one or more amplitude associated with the one or more sound sources is configured to control the apparatus operation.

The apparatus may further comprise a sound motion determiner configured to determine at least one sound motion associated with the one or more sound sources; and the user interface input generator may be further configured to generate at least one user interface input based on the one or more sound motion associated with the one or more sound sources, such that the one or more motion associated with the one or more sound sources is configured to control the apparatus operation.

The sound motion determiner may be configured to: determine at least one sound source direction at a first time; determine at least one sound source at a second time after the first time; and determine the difference between the at least one sound source direction at a first time and the at least one sound source at a second time.

The at least one sound source may comprise at least one of: an impact sound on a surface on which the apparatus is located; a contact sound on a surface on which the apparatus is located; a ‘tap’ sound on a surface on which the apparatus is located; and a ‘dragging’ sound on a surface on which the apparatus is located.

The user interface input generator may comprise: a region definer configured to define at least one region comprising a range of directions; and an region user input generator configured to generate a user interface input based on the at least one direction associated with the one or more sound sources being within the at least one region.

The region definer may be configured to define at least two regions, each region comprising a range of directions, and the region user input generator may be configured to generate a first user interface input based on a first of the at least one direction being within a first of the at least two regions and generate a second user interface input based on the a second of the at least one direction being within a second of the at least two regions.

The at least two regions may comprise at least one of: the first region range of directions and second region range of directions at least partially overlapping; the first region range of directions and second region range of directions adjoining; and the first region range of directions and second region range of directions being separate.

The user input generator may be configured to generate at least one of: a drum simulator input; a visual interface input; a scrolling input; a panning input; a focus selection input; a user interface button simulation input; a make call input; an end call input; a mute call input; a handsfree operation input; a volume control input; a media control input; a multitouch simulation input; a rotate display element input; a zoom display element input; a clock setting input; and a game user interface input.

The sound direction determiner may be configured to determine a first direction associated with a first sound source and determine a second direction associated with a second sound source, and wherein the user interface input generator may be configured to generate the user interface input based on the first direction and the second direction.

The sound direction determiner may be configured to determine a first direction associated with a first sound source over a first range of directions and determine a second direction associated with a second sound source over a second separate range of directions, and the user interface input generator may be configured to generate a simulated multi-touch user interface input based on the first and second directions.

The sound direction determiner may be configured to determine a first direction associated with a first sound source and determine a second direction associated with a second sound source subsequent to the first sound source, and the user interface input generator may be configured to generate a first of the user interface inputs based on the first direction, and a second of the user interface inputs based on the second direction and conditional on the first direction.

According to a second aspect there is provided an apparatus comprising at least one processor and at least one memory including computer code for one or more programs, the at least one memory and the computer code configured to with the at least one processor cause the apparatus to at least perform: receiving at least one detected acoustic signal from one or more sound sources; determining one or more directions associated with the one or more sound sources based on the detected at least one acoustic signal; and generating at least one user interface input based on the one or more directions, wherein the user interface input is configured to control the apparatus operation.

The apparatus may further perform displaying and/or receiving at least one information of at least one user interface for the apparatus operation.

The apparatus may further perform detecting at least one acoustic signal from the one or more sound sources.

Determining one or more directions associated with the one or more sound sources based on the detected at least one acoustic signal may cause the apparatus to perform determining the one or more directions associated with the one or more sound sources based on the detected at least one acoustic signal relative to the apparatus.

Receiving at least one detected acoustic signal from one or more sound sources configured to receive at least one detected acoustic signal may cause the apparatus to perform receiving at least a first audio signal input from a first microphone and at least a second audio signal input from a second microphone.

Determining one or more directions associated with the one or more sound sources based on the detected at least one acoustic signal may cause the apparatus to perform: identifying at least one common audio signal component within the at least one first audio signal and the at least one second audio signal; and determining a difference between the at least one common component such that the difference defines the one or more directions.

The apparatus may further be caused to perform determining at least one sound amplitude associated with the one or more sound sources; and generating at least one user interface input may cause the apparatus to perform generating at least one user interface input based on the one or more amplitude associated with the one or more sound sources, such that the one or more amplitude associated with the one or more sound sources is configured to control the apparatus operation.

The apparatus may further be caused to perform determining at least one sound motion associated with the one or more sound sources; and generating at least one user interface input may cause the apparatus to perform generating at least one user interface input based on the one or more sound motion associated with the one or more sound sources, such that the one or more motion associated with the one or more sound sources is configured to control the apparatus operation.

Determining one or more directions associated with the one or more sound sources based on the detected at least one acoustic signal may cause the apparatus to perform: determining at least one sound source direction at a first time; determining at least one sound source at a second time after the first time; and determining the difference between the at least one sound source direction at a first time and the at least one sound source at a second time.

The at least one sound source may comprise at least one of: an impact sound on a surface on which the apparatus is located; a contact sound on a surface on which the apparatus is located; a ‘tap’ sound on a surface on which the apparatus is located; and a ‘dragging’ sound on a surface on which the apparatus is located.

Generating at least one user interface input may cause the apparatus to perform: defining at least one region comprising a range of directions; and generating a user interface input based on the at least one direction associated with the one or more sound sources being within the at least one region.

Defining at least one region comprising a range of directions may cause the apparatus to perform defining at least two regions, each region comprising a range of directions, and the generating a user interface input based on the at least one direction associated with the one or more sound sources being within the at least one region may cause the apparatus to generate a first user interface input based on a first of the at least one direction being within a first of the at least two regions and generate a second user interface input based on the a second of the at least one direction being within a second of the at least two regions.

The at least two regions may comprise at least one of: the first region range of directions and second region range of directions at least partially overlapping; the first region range of directions and second region range of directions adjoining; and the first region range of directions and second region range of directions being separate.

The generating a user interface input may cause the apparatus to perform at least one of: generating a drum simulator input; generating a visual interface input; generating a scrolling input; generating a panning input; generating a focus selection input; generating a user interface button simulation input; generating a make call input; generating a end call input; generating a mute call input; generating a handsfree operation input; generating a volume control input; generating a media control input; generating a multitouch simulation input; generating a rotate display element input; generating a zoom display element input; generating a clock setting input; and generating a game user interface input.

Determining one or more directions associated with the one or more sound sources based on the detected at least one acoustic signal may cause the apparatus to perform determining a first direction associated with a first sound source and determining a second direction associated with a second sound source, and wherein generating a user interface input may cause the apparatus to perform generating the user interface input based on the first direction and the second direction.

Determining one or more directions associated with the one or more sound sources based on the detected at least one acoustic signal may cause the apparatus to perform determining a first direction associated with a first sound source over a first range of directions and determining a second direction associated with a second sound source over a second separate range of directions, and the generating a user interface input may cause the apparatus to perform generate a simulated multi-touch user interface input based on the first and second directions.

Determining one or more directions associated with the one or more sound sources based on the detected at least one acoustic signal may cause the apparatus to perform determining a first direction associated with a first sound source and determining a second direction associated with a second sound source subsequent to the first sound source, and the generating a user interface input may cause the apparatus to perform generating a first of the user interface inputs based on the first direction, and a second of the user interface inputs based on the second direction and conditional on the first direction.

According to a third aspect there is provided an apparatus comprising: means for receiving at least one detected acoustic signal from one or more sound sources; means for determining one or more directions associated with the one or more sound sources based on the detected at least one acoustic signal; and means for generating at least one user interface input based on the one or more directions, wherein the user interface input is configured to control the apparatus operation.

The apparatus may further comprise means for displaying and/or receiving at least one information of at least one user interface for the apparatus operation.

The apparatus may further comprise means for detecting at least one acoustic signal from the one or more sound sources.

The means for determining one or more directions associated with the one or more sound sources based on the detected at least one acoustic signal may comprise means for determining the one or more directions associated with the one or more sound sources based on the detected at least one acoustic signal relative to the apparatus.

The means for receiving at least one detected acoustic signal from one or more sound sources configured to receive at least one detected acoustic signal may comprise means for receiving at least a first audio signal input from a first microphone and at least a second audio signal input from a second microphone.

The means for determining one or more directions associated with the one or more sound sources based on the detected at least one acoustic signal may comprise: means for identifying at least one common audio signal component within the at least one first audio signal and the at least one second audio signal; and means for determining a difference between the at least one common component such that the difference defines the one or more directions.

The apparatus may further comprise means for determining at least one sound amplitude associated with the one or more sound sources; and the means for generating at least one user interface input may comprise means for generating at least one user interface input based on the one or more amplitude associated with the one or more sound sources, such that the one or more amplitude associated with the one or more sound sources is configured to control the apparatus operation.

The apparatus may further comprise means for determining at least one sound motion associated with the one or more sound sources; and the means for generating at least one user interface input may comprise means for generating at least one user interface input based on the one or more sound motion associated with the one or more sound sources, such that the one or more motion associated with the one or more sound sources is configured to control the apparatus operation.

The means for determining one or more directions associated with the one or more sound sources based on the detected at least one acoustic signal may comprise: means for determining at least one sound source direction at a first time; means for determining at least one sound source at a second time after the first time; and means for determining the difference between the at least one sound source direction at a first time and the at least one sound source at a second time.

The at least one sound source may comprise at least one of: an impact sound on a surface on which the apparatus is located; a contact sound on a surface on which the apparatus is located; a ‘tap’ sound on a surface on which the apparatus is located; and a ‘dragging’ sound on a surface on which the apparatus is located.

The means for generating at least one user interface input may comprise: means for defining at least one region comprising a range of directions; and means for generating a user interface input based on the at least one direction associated with the one or more sound sources being within the at least one region.

The means for defining at least one region comprising a range of directions may comprise means for defining at least two regions, each region comprising a range of directions, and the means for generating a user interface input based on the at least one direction associated with the one or more sound sources being within the at least one region may comprise means for generating a first user interface input based on a first of the at least one direction being within a first of the at least two regions and means for generating a second user interface input based on the a second of the at least one direction being within a second of the at least two regions.

The at least two regions may comprise at least one of: the first region range of directions and second region range of directions at least partially overlapping; the first region range of directions and second region range of directions adjoining; and the first region range of directions and second region range of directions being separate.

The means for generating a user interface input may comprise at least one of: means for generating a drum simulator input; means for generating a visual interface input; means for generating a scrolling input; means for generating a panning input; means for generating a focus selection input; means for generating a user interface button simulation input; means for generating a make call input; means for generating an end call input; means for generating a mute call input; means for generating a handsfree operation input; means for generating a volume control input; means for generating a media control input; means for generating a multitouch simulation input; means for generating a rotate display element input; means for generating a zoom display element input; means for generating a clock setting input; and means for generating a game user interface input.

The means for determining one or more directions associated with the one or more sound sources based on the detected at least one acoustic signal may comprise means for determining a first direction associated with a first sound source and means for determining a second direction associated with a second sound source, and wherein the means for generating a user interface input may comprise means for generating the user interface input based on the first direction and the second direction.

The means for determining one or more directions associated with the one or more sound sources based on the detected at least one acoustic signal may comprise means for determining a first direction associated with a first sound source over a first range of directions and means for determining a second direction associated with a second sound source over a second separate range of directions, and the means for generating a user interface input may comprise means for generating a simulated multi-touch user interface input based on the first and second directions.

The means for determining one or more directions associated with the one or more sound sources based on the detected at least one acoustic signal may comprise means for determining a first direction associated with a first sound source and means for determining a second direction associated with a second sound source subsequent to the first sound source, and the means for generating a user interface input may comprise means for generating a first of the user interface inputs based on the first direction, and a second of the user interface inputs based on the second direction and conditional on the first direction.

According to a fourth aspect there is provided a method comprising: receiving at least one detected acoustic signal from one or more sound sources; determining one or more directions associated with the one or more sound sources based on the detected at least one acoustic signal; and generating at least one user interface input based on the one or more directions, wherein the user interface input is configured to control the apparatus operation.

The method may further comprise displaying and/or receiving at least one information of at least one user interface for the apparatus operation.

The method may further comprise means for detecting at least one acoustic signal from the one or more sound sources.

Determining one or more directions associated with the one or more sound sources based on the detected at least one acoustic signal may comprise determining the one or more directions associated with the one or more sound sources based on the detected at least one acoustic signal relative to the apparatus.

Receiving at least one detected acoustic signal from one or more sound sources configured to receive at least one detected acoustic signal may comprise receiving at least a first audio signal input from a first microphone and at least a second audio signal input from a second microphone.

Determining one or more directions associated with the one or more sound sources based on the detected at least one acoustic signal may comprise: identifying at least one common audio signal component within the at least one first audio signal and the at least one second audio signal; and determining a difference between the at least one common component such that the difference defines the one or more directions.

The method may further comprise determining at least one sound amplitude associated with the one or more sound sources; and generating at least one user interface input may comprise generating at least one user interface input based on the one or more amplitude associated with the one or more sound sources, such that the one or more amplitude associated with the one or more sound sources is configured to control the apparatus operation.

The method may further comprise determining at least one sound motion associated with the one or more sound sources; and generating at least one user interface input may comprise generating at least one user interface input based on the one or more sound motion associated with the one or more sound sources, such that the one or more motion associated with the one or more sound sources is configured to control the apparatus operation.

Determining one or more directions associated with the one or more sound sources based on the detected at least one acoustic signal may comprise: determining at least one sound source direction at a first time; determining at least one sound source at a second time after the first time; and determining the difference between the at least one sound source direction at a first time and the at least one sound source at a second time.

The at least one sound source may comprise at least one of: an impact sound on a surface on which the apparatus is located; a contact sound on a surface on which the apparatus is located; a ‘tap’ sound on a surface on which the apparatus is located; and a ‘dragging’ sound on a surface on which the apparatus is located.

Generating at least one user interface input may comprise: defining at least one region comprising a range of directions; and generating a user interface input based on the at least one direction associated with the one or more sound sources being within the at least one region.

Defining at least one region comprising a range of directions may comprise defining at least two regions, each region comprising a range of directions, and generating a user interface input based on the at least one direction associated with the one or more sound sources being within the at least one region may comprise generating a first user interface input based on a first of the at least one direction being within a first of the at least two regions and generating a second user interface input based on the a second of the at least one direction being within a second of the at least two regions.

The at least two regions may comprise at least one of: the first region range of directions and second region range of directions at least partially overlapping; the first region range of directions and second region range of directions adjoining; and the first region range of directions and second region range of directions being separate.

Generating a user interface input may comprise at least one of: generating a drum simulator input; generating a visual interface input; generating a scrolling input; generating a panning input; generating a focus selection input; generating a user interface button simulation input; generating a make call input; generating an end call input; generating a mute call input; generating a handsfree operation input; generating a volume control input; generating a media control input; generating a multitouch simulation input; generating a rotate display element input; generating a zoom display element input; generating a clock setting input; and generating a game user interface input.

Determining one or more directions associated with the one or more sound sources based on the detected at least one acoustic signal may comprise determining a first direction associated with a first sound source and determining a second direction associated with a second sound source, and wherein generating a user interface input may comprise generating the user interface input based on the first direction and the second direction.

Determining one or more directions associated with the one or more sound sources based on the detected at least one acoustic signal may comprise determining a first direction associated with a first sound source over a first range of directions and determining a second direction associated with a second sound source over a second separate range of directions, and generating a user interface input may comprise generating a simulated multi-touch user interface input based on the first and second directions.

Determining one or more directions associated with the one or more sound sources based on the detected at least one acoustic signal may comprise determining a first direction associated with a first sound source and determining a second direction associated with a second sound source subsequent to the first sound source, and the generating a user interface input may comprise generating a first of the user interface inputs based on the first direction, and a second of the user interface inputs based on the second direction and conditional on the first direction.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For better understanding of the present application, reference will now be made by way of example to the accompanying drawings in which:

FIG. 1 shows schematically an apparatus suitable for being employed in some embodiments;

FIG. 2 shows schematically an example concept of some embodiments with respect to a suitable portable apparatus;

FIG. 3 shows schematically an example audio user input apparatus according to some embodiments;

FIG. 4 shows schematically a flow diagram of the operation of the example audio user input apparatus as shown in FIG. 3 according to some embodiments;

FIG. 5 shows schematically an example audio user input apparatus suitable for determining ‘tap’ inputs and implementing a virtual drum application;

FIG. 6 shows schematically an example audio user input apparatus suitable for determining ‘dragged’ inputs and implementing a scrolling operation;

FIG. 7 shows schematically an example audio user input apparatus suitable for determining ‘tap’ inputs and implementing a window focus shift operation;

FIG. 8 shows schematically an example audio user input apparatus suitable for determining ‘tap’ inputs and implementing ‘virtual button’ operations;

FIG. 9 shows schematically an example audio user input apparatus suitable for determining ‘tap’ inputs and implementing media control operations;

FIG. 10 shows schematically an example audio user input apparatus suitable for determining multiple concurrent ‘dragged’ inputs and implementing an object rotation operation;

FIG. 11 shows schematically an example audio user input apparatus suitable for determining multiple concurrent ‘dragged’ inputs and implementing an object zoom operation;

FIG. 12 shows schematically an example audio user input apparatus suitable for determining multiple concurrent ‘dragged’ inputs and implementing an object zoom out operation;

FIG. 13 shows schematically an example audio user input apparatus suitable for determining multiple ‘tap’ inputs for implementing an alarm clock operation; and

FIG. 14 shows schematically an example audio user input apparatus suitable for determining ‘tap’ input direction and sound pressure level for implementing two-variable user inputs.

### EMBODIMENTS

The following describes in further detail suitable apparatus and possible mechanisms for the provision of novel directional sound based user interface inputs.

As described herein (and considering a mobile phone as a typical example) user interface inputs are becoming increasingly reliant on touch screen technology which registers one or more points where the user is touching the surface of the display. This type of user interface is very intuitive but can have constraints.

For example the interface is limited by and defined by the device size. Also the use of the display as a user interface input further decreases the display area available to display other information. Thus for example a touch screen display can lose a significant proportion of the display when a virtual keyboard or keypad is required. In other words a device screen can be blocked from displaying information where the device has to provide a touch input. Thus in some applications it can become annoying for the user to constantly move their hands from blocking the screen to see what is rendered by their input.

Furthermore for different kinds of input methods the use of a touch screen can be limiting, for example where the input is for a special application such as a simulated musical instrument. Simulating an instrument input using a touch screen can make the simulated instrument extremely hard to play as the user will find it hard to get full interactivity of (and emulation of) playing the instrument. Considering the requirements for ‘virtual’ drums the physical area of the touch screen is generally totally inadequate for the purpose of providing, an input and providing a reliable indication of how hard the user is hitting the ‘drum’ is difficult if not practically impossible to achieve.

The concept of some embodiments as described herein is thus to describe a method of utilising spatial audio capture and audio directionality for incoming sounds to generate an input method for user interface signals. Thus as described herein producing sounds around the apparatus can be used as a method of input rather than using a touchscreen, mouse or keyboard.

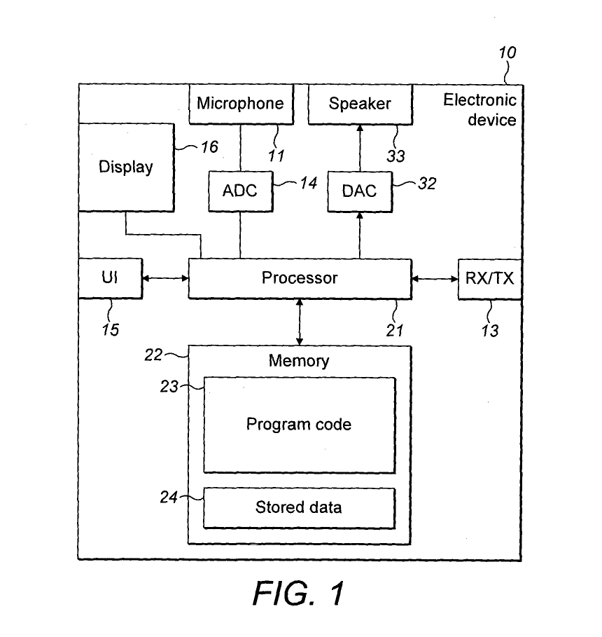

In this regard reference is first made to FIG. 1 which shows a schematic block diagram of an exemplary apparatus or electronic device 10, which may implement the sound or audio based used interface embodiments described herein.

The apparatus 10 may for example be a mobile terminal or user equipment of a wireless communication system. In some embodiments the apparatus can be an audio player or audio recorder, such as an MP3 player, a media recorder/player (also known as an MP4 player), or any suitable portable apparatus suitable for recording audio or audio/video camcorder/memory audio or video recorder.

The apparatus 10 can in some embodiments comprise an audio subsystem. The audio subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or micro electrical-mechanical system (MEMS) microphone. In some embodiments the microphone 11 is a digital microphone array, in other words configured to generate a digital signal output (and thus not requiring an analogue-to-digital converter). The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means. In some embodiments the microphones are ‘integrated’ microphones containing both audio signal generating and analogue-to-digital conversion capability.

In some embodiments the apparatus 10 audio subsystems further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio subsystem can comprise in some embodiments a speaker 33. The speaker 33 can in some embodiments receive the output from the digital-to-analogue converter 32 and present the analogue audio signal to the user. In some embodiments the speaker 33 can be representative of multi-speaker arrangement, a headset, for example a set of headphones, or cordless headphones.

Although the apparatus 10 is shown having both audio capture and audio presentation components, it would be understood that in some embodiments the apparatus 10 can comprise one or the other of the audio capture and audio presentation parts of the audio subsystem such that in some embodiments of the apparatus the microphone (for audio capture) or the speaker (for audio presentation) are present.

In some embodiments the apparatus 10 comprises a processor 21. The processor 21 is coupled to the audio subsystem and specifically in some examples the analogue-to-digital converter 14 for receiving digital signals representing audio signals from the microphone 11, and the digital-to-analogue converter (DAC) 12 configured to output processed digital audio signals. The processor 21 can be configured to execute various program codes. The implemented program codes can comprise for example audio analysis and audio parameter to user interface conversion routines. In some embodiments the program codes can be configured to perform routine which request user interface inputs such as described herein.

In some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21.

Furthermore in some embodiments the memory 22 can further comprise a stored data section 24 for storing data, for example data that has been processed in accordance with the application or data to be processed as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The transceiver 13 can communicate with further apparatus by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the apparatus comprises a display 16 coupled to the processor 21 and configured to provide a visual display for the user. In some embodiments the display 16 and the user interface 15 are implemented as a single touch screen display.

It is to be understood again that the structure of the electronic device 10 could be supplemented and varied in many ways.

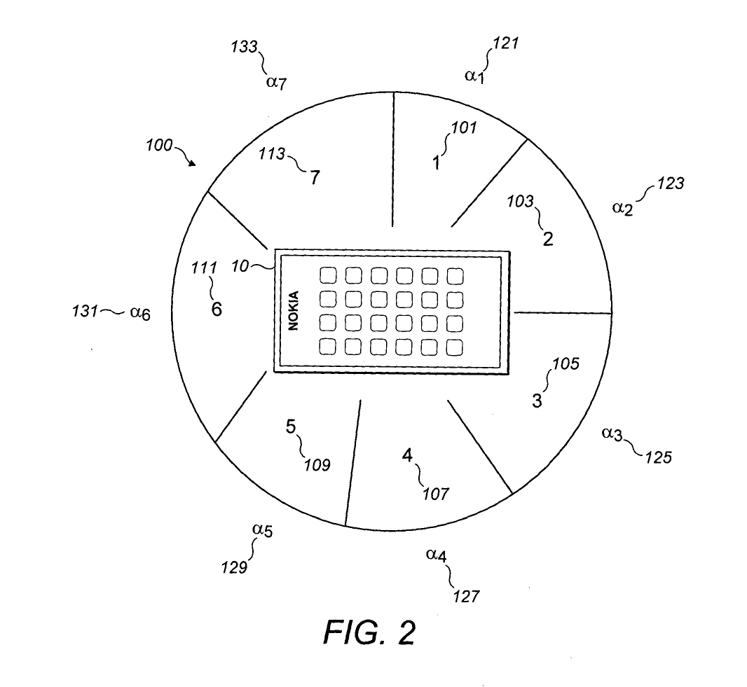

With respect to FIG. 2 an example overview of the audio signal user interface input concept is shown. An apparatus 10 as shown in FIG. 2 is located on a surface 100. An example of a surface for example can be a table top. The surface can be any surface suitable for generating a sound when touched. In some embodiments the surface can be grained, in other words produce a specific sound signal when a finger, nail or other object is dragged across the surface in one direction when compared to a different direction however in some embodiments the surface can have has no grain effect or be substantially uniform with respect to producing a sound when an object is dragged across it.

In the example shown in FIG. 2 the surface on which the apparatus 10 is placed is divided into input regions. The apparatus can in some embodiments be configured to analyse any received audio signals and specifically the direction of the audio signals and then generate a user input based on the direction (region) from which the audio signal is from.

In the example shown in FIG. 2 the surface 100 is divided into seven regions which clockwise from an arbitrary ‘up’ direction are: a first region 1 101; a second region 2 103; a third region 3 105; a fourth region 4 107; a fifth region 5 109; a sixth region 6 111; and a seventh region 7 113.

The apparatus 10 can furthermore be configured such that a ‘tap’ sound made when the user taps the surface from each of these reasons can be converted into a specific user input. In other words a sound region 1 is associated with a first user interface input value α₁ 121, a sound from region 2 is associated with a second user interface input value α₂ 123, a sound from region 3 is associated with a third user interface input value α₃ 125, a sound from region 4 is associated with a fourth user interface input value α₄ 127, a sound from region 5 is associated with a fifth user interface input value α₅ 129, a sound from region 6 is associated with a sixth user interface input value α₆ 131 and a sound from region 7 is associated with a seventh user interface input value α₇133.

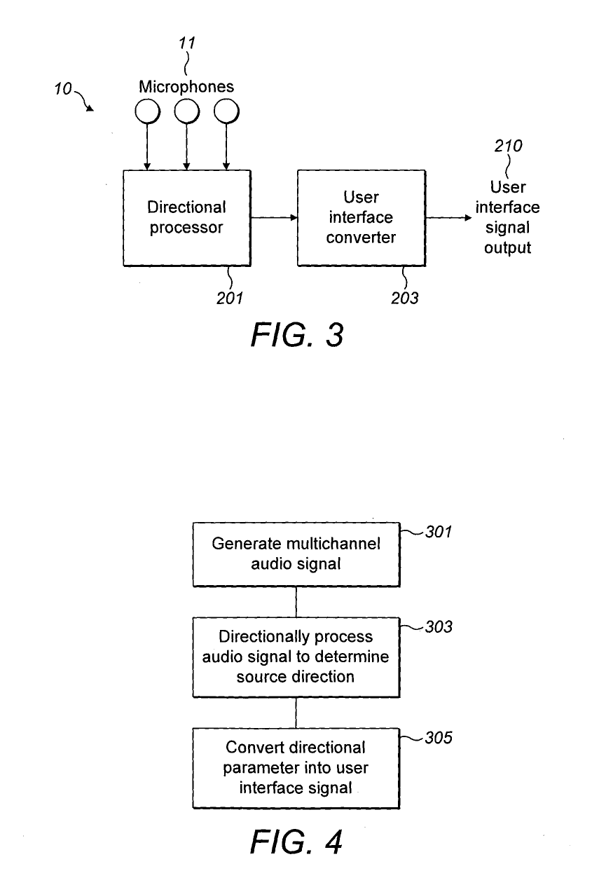

The apparatus suitable for generating the user interface signals is shown with respect to FIG. 3. Furthermore with respect to FIG. 4 the operation of the apparatus shown in FIG. 3 is described.

In some embodiments the apparatus 10 comprises a microphone array 11, such as described herein with respect to FIG. 1, configured to generate audio signals from the acoustic waves in the neighbourhood of the apparatus. It would be understood that in some embodiments the microphone array 11 is not physically coupled or attached to the recording apparatus (for example the microphones can be attached to a headband or headset worn by the user of the recording apparatus) and can transmit the audio signals to the recording apparatus. For example the microphones mounted on a headset or similar apparatus are coupled by a wired or wireless coupling to the recording apparatus.

The microphones 11 can be configured to output the audio signal to a directional processor 201.

The operation of generating audio signals from the microphones is shown in FIG. 4 by step 401.

In some embodiments the apparatus comprises a directional processor 201. The directional processor 201 is configured to receive the audio signals and generate at least a directional parameter which can be passed to a user interface converter 203.

In some embodiments the directional processor 201 can be configured to receive or determine the microphone array orientation. In some embodiments, the directional processor 201 can sub-divide the microphone array inputs according to orientation. For example as described herein in some embodiments concurrent audio ‘tap’ or ‘dragging’ sound inputs are to be processed. In some embodiments the directional processor 201 can be configured to divide the array into directional groups, for example a ‘top’ microphone array group with microphones directed on the ‘top’ side or edge of the apparatus, a ‘bottom’ microphone array group with microphones directed on the ‘bottom’ side or edge of the apparatus, a ‘left’ microphone array group with microphones directed on the ‘left’ side or edge of the apparatus and a ‘right’ microphone array group with microphones directed on the ‘right’ side or edge of the apparatus. In such embodiments each of the groups of signals can be processed separately to determine whether there are multiple sound inputs from different directions.

The directional processor 201 can be configured in some embodiments to perform audio signal processing on the received audio signals to determine whether there has been an audio signal input, and any parameters associated with the audio signal input such as orientation or direction and the sound pressure level or volume of the input.

For example in some embodiments the directional processor 201 can be configured to process the audio signals generated from the microphones to determine spatial information or parameters from the audio signal.

An example directional analysis of the audio signal is described as follows. However it would be understood that any suitable audio signal directional analysis in either the time or other representational domain (frequency domain etc) can be used.

In some embodiments the directional processor 201 comprises a framer. The framer or suitable framer means can be configured to receive the audio signals from the microphones and divide the digital format signals into frames or groups of audio sample data. In some embodiments the framer can furthermore be configured to window the data using any suitable windowing function. The framer can be configured to generate frames of audio signal data for each microphone input wherein the length of each frame and a degree of overlap of each frame can be any suitable value. For example in some embodiments each audio frame is 20 milliseconds long and has an overlap of 10 milliseconds between frames. The framer can be configured to output the framed audio data to a Time-to-Frequency Domain Transformer.

In some embodiments the directional processor comprises a Time-to-Frequency Domain Transformer. The Time-to-Frequency Domain Transformer or suitable transformer means can be configured to perform any suitable time-to-frequency domain transformation on the framed audio data. In some embodiments the Time-to-Frequency Domain Transformer can be a Discrete Fourier Transformer (DFT). However the Transformer can be any suitable Transformer such as a Discrete Cosine Transformer (DCT), a Modified Discrete Cosine Transformer (MDCT), a Fast Fourier Transformer (FFT) or a quadrature mirror filter (QMF). The Time-to-Frequency Domain Transformer can be configured to output a frequency domain signal for each microphone input to a sub-band filter.

In some embodiments the directional processor 301 comprises a sub-band filter. The sub-band filter or suitable means can be configured to receive the frequency domain signals from the Time-to-Frequency Domain Transformer for each microphone and divide each microphone audio signal frequency domain signal into a number of sub-bands.

The sub-band division can be any suitable sub-band division. For example in some embodiments the sub-band filter can be configured to operate using psychoacoustic filtering bands. The sub-band filter can then be configured to output each domain range sub-band to a direction analyser.

In some embodiments the directional processor 301 can comprise a direction analyser. The direction analyser or suitable means can in some embodiments be configured to select a sub-band and the associated frequency domain signals for each microphone of the sub-band.

The directional analyser can then be configured to perform directional analysis on the signals in the sub-band. The directional analyser can be configured in some embodiments to perform a cross correlation between the microphone/decoder sub-band frequency domain signals within a suitable processing means.

In the direction analyser the delay value of the cross correlation is found which maximises the cross correlation of the frequency domain sub-band signals. This delay can in some embodiments be used to estimate the angle or represent the angle from the dominant audio signal source for the sub-band. This angle can be defined as a. It would be understood that whilst a pair or two microphones can provide a first angle, an improved directional estimate can be produced by using more than two microphones and preferably in some embodiments more than two microphones on two or more axes.

The directional analyser can then be configured to determine whether or not all of the sub-bands have been selected. Where all of the sub-bands have been selected in some embodiments then the direction analyser can be configured to output the directional analysis results. Where not all of the sub-bands have been selected then the operation can be passed back to selecting a further sub-band processing step.

The above describes a direction analyser performing an analysis using frequency domain correlation values. However it would be understood that the directional analysis can use any suitable method. For example in some embodiments directional analysis can be configured to output specific azimuth (orientation) values rather than maximum correlation delay values. Furthermore in some embodiments the spatial analysis can be performed in the time domain.

In some embodiments this direction analysis can therefore be defined as receiving the audio sub-band data;

Xₖ^{b}(n)=Xₖ(n_{b}+n),n=0, . . . , n_{b+1}−n_{b}−1,b=0, . . . , B−1

where n_{b} is the first index of bth subband. In some embodiments for every subband the directional analysis as described herein as follows. First the direction is estimated with two channels (or microphones audio signal subbands). The direction analyser finds delay τ_{b} that maximizes the correlation between the two channels for subband b. DFT domain representation of e.g. Xₖ^{b} (n) can be shifted τ_{b} time domain samples using

$${X}_{k , {τ}_{b}}^{b} ( n ) = {X}_{k}^{b} ( n ) {e}^{- j \frac{\text{?} π n {τ}_{b}}{N}} . \\ \text{?} \text{indicates text missing or illegible when filed}$$

The optimal delay in some embodiments can be obtained from

$${max}_{{τ}_{b}} Re ( {\sum }_{n = 0}^{{n}_{b + 1} - {n}_{b} - 1} ( {{X}_{2 , {τ}_{b}}^{b} ( n )}^{*} {X}_{\text{?}}^{b} ( n ) ) ) , {τ}_{b} ∈ [ - {D}_{tot} , {D}_{tot} ] \\ \text{?} \text{indicates text missing or illegible when filed}$$

where Re indicates the real part of the result and * denotes complex conjugate. X_{2,τ}_{_{b}}^{b} and Xₐ^{b} are considered vectors with length of n_{b+1}−n_{b} samples. The directional analyser can in some embodiments implement a resolution of one time domain sample for the search of the delay.

In some embodiments the directional analyser can be configured to generate a sum signal. The sum signal can be mathematically defined as.

$${X}_{sum}^{b} = \{ \begin{matrix}( {X}_{2 , {τ}_{b}}^{b} + {X}_{\text{?}}^{b} ) / 2 & {τ}_{b} \leq 0 \\ ( {X}_{2}^{b} + {X}_{\text{?} - {τ}_{b}}^{b} ) / 2 & {τ}_{b} > 0\end{matrix} \\ \text{?} \text{indicates text missing or illegible when filed}$$

In other words the object detector and separator is configured to generate a sum signal where the content of the channel in which an event occurs first is added with no modification, whereas the channel in which the event occurs later is shifted to obtain best match to the first channel.

It would be understood that the delay or shift τ_{b} indicates how much closer the sound source is to one microphone (or channel) than another microphone (or channel). The direction analyser can be configured to determine actual difference in distance as

$${Δ}_{22} = \frac{v {τ}_{b}}{{F}_{\text{?}}}$$

$$\text{?} \text{indicates text missing or illegible when filed}$$

where Fs is the sampling rate of the signal and v is the speed of the signal in air (or in water if we are making underwater recordings).

The angle of the arriving sound is determined by the direction analyser as,

$${\dot{α}}_{b} = \pm {cos}^{- 1} ( \frac{{Δ}_{22}^{2} + 2 b {Δ}_{22} - {d}^{2}}{2 db} )$$

where d is the distance between the pair of microphones/channel separation and b is the estimated distance between sound sources and nearest microphone. In some embodiments the direction analyser can be configured to set the value of b to a fixed value. For example b=2 meters has been found to provide stable results.

It would be understood that the determination described herein provides two alternatives for the direction of the arriving sound as the exact direction cannot be determined with only two microphones/channels.

In some embodiments the directional analyser can be configured to use audio signals from a third channel or the third microphone to define which of the signs in the determination is correct. The distances between the third channel or microphone and the two estimated sound sources are:

δ_{b}⁺={square root over ((h+b sin(\dot{α}_{b}))²+(d/2+b cos(\dot{α}_{b}))²)}

δ_{b}⁻={square root over ((h+b sin(\dot{α}_{b}))²+(d/2+b cos(\dot{α}_{b}))²)}

where h is the height of an equilateral triangle (where the channels or microphones determine a triangle), i.e.

$$h = \frac{\sqrt{\text{?}}}{2} d . \\ \text{?} \text{indicates text missing or illegible when filed}$$

The distances in the above determination can be considered to be equal to delays (in samples) of;

$${τ}_{b}^{+} = \frac{{δ}^{+} - b}{v} {F}_{s}$$

$${τ}_{b}^{-} = \frac{{δ}^{-} - b}{v} {F}_{s}$$

Out of these two delays the object detector and separator in some embodiments is configured to select the one which provides better correlation with the sum signal. The correlations can for example be represented as

$${c}_{b}^{+} = Re ( {\sum }_{n = 0}^{{n}_{b + 1} - {n}_{b} - 1} ( {{X}_{sum , {τ}_{b}^{+}}^{b} ( n )}^{*} {X}_{1}^{b} ( n ) ) )$$

$${c}_{b}^{-} = Re ( {\sum }_{n = 0}^{{n}_{b + 1} - {n}_{b} - 1} ( {{X}_{sum , {τ}_{b}^{-}}^{b} ( n )}^{*} {X}_{1}^{b} ( n ) ) )$$

The directional analyser can then in some embodiments then determine the direction of the dominant sound source for subband b as:

$${α}_{b} = \{ \begin{matrix}\dot{{α}_{b}} & {c}_{b}^{+} \geq {c}_{b}^{-} \\ \dot{- {α}_{b}} & {c}_{b}^{+} < {c}_{b}^{-}\end{matrix} .$$

The directional processor 201 can then, having determined spatial parameters from the recorded audio signals, be configured to output the direction of the dominant sound source for at least one of the subbands.

Furthermore by using the sum value the power value of the dominant signal can be determined using any suitable power determination method. For example the sum value X^{b}ₛᵤₘ values can be squared and summed over each frame. In some embodiments this power value of the dominant signal can be used to determine a ‘tap’ or ‘dragging’ input strength or level parameter and further be passed to the user interface converter 203.

The operation of directionally processing the audio signal to determine a source direction is shown in FIG. 4 by step 303.

The apparatus further comprises a user interface converter 203. The user interface converter 203 can be configured to receive the directional information (and other sound parameters) from the directional processor 201 and convert this information into a user interface signal which is output on a user interface signal output.

The user interface converter 203 in some embodiments can be configured to generate a user interface input signal based on at least one of the direction of the input sound, the motion of the input sound and the volume or power of the input sound.

In some embodiments the directional processor 201 or user interface converter 203 performs the sound based user interface signal generation dependent on some of the sub-bands. In other words the sound is bandfiltered. For example in the examples provided herein the sound or audio signals processed are the sounds produced when tapping or dragging an object over a surface on which the apparatus is located. In such embodiments the directional processor 201 can be configured to perform directional and power level analysis only on the frequency range (subbands) for such ‘tap’ or ‘dragging’ sounds.

However it would be understood that in some embodiments the sound input can be any suitable sound, such as vocal sounds, handclapping, and finger-clicking.

In some embodiments the conversion is apparatus specific. In other words the apparatus generates a specific user interface input for a specific direction/volume input, for example a make call user interface input for a sound from the left of the apparatus and an end call user interface input for a sound from the right of the apparatus. In some embodiments the conversion is condition specific. In other words the apparatus generates a specific user interface input for a specified direction/volume when the apparatus is operating in a defined condition, for example generating a make call user interface input for a sound from the left of the apparatus and when the apparatus is receiving a call, whereas for a sound from the left of the apparatus when the apparatus is playing a media file the user interface input generated is a return to start of file request input.

The operation of converting the directional parameter into user interface signal is shown in FIG. 4 by step 305.

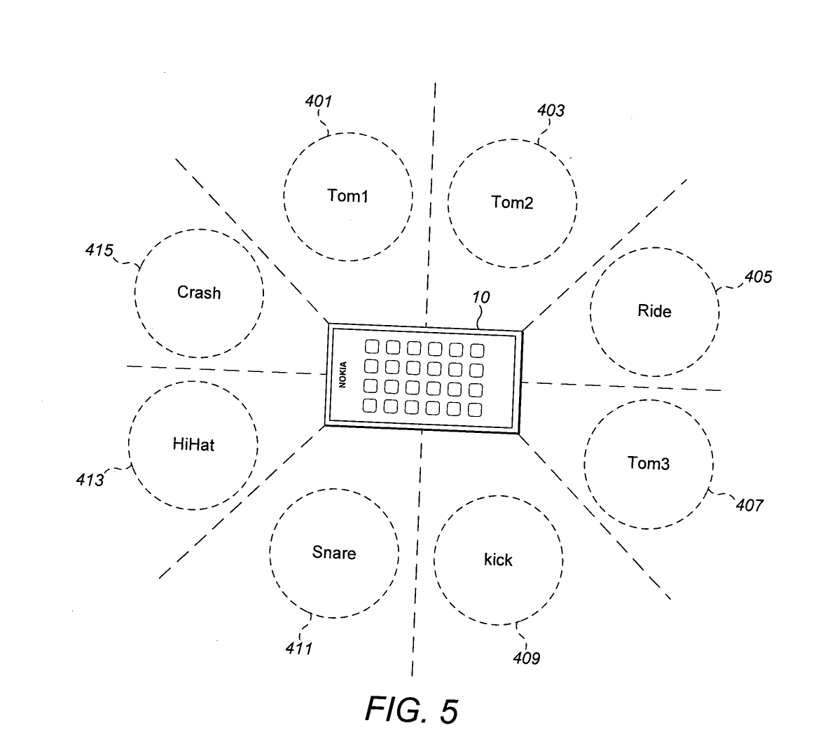

With respect to FIGS. 5 to 14 a series of example use cases are shown.

As described herein playing a virtual instrument using a mobile device and particularly a mobile device with the form factor of a mobile phone generally does not produce a good user experience. With respect to FIG. 5 an example virtual drum input simulation is shown operating on the apparatus 10.

In such embodiments the user interface converter 203 can be configured to define a direction region or arc surrounding the apparatus. The user interface converter 203 can then associate the regions or arcs with a drum identifier label. In other words a ‘tap’ direction on a surface on which the apparatus is operating generates a ‘drum’ type value which then can be processed by a suitable drum audio simulator to generate a drumming sound. Furthermore in some embodiments the user interface converter can be configured to receive the power level of the ‘tap’ signal and generate a ‘drum volume’ user interface input signal which can be passed to the suitable drum audio simulator.

Thus for example as shown in FIG. 5, the user interface converter 203 can be configured to define eight regions with which are approximately equal in size such that the user interface signal generated is Tom2 drum 403 when the ‘tap’ sound direction is approximately from 0° to 45°, a Ride drum 405 from 45° to 90°, a Tom3 drum 407 from 90° to 235°, a Kick drum 409 from 135° to 180°, a Snare drum 411 from 180° to 225°, a HiHat drum 413 from 235° to 270°, a Crash drum 415 from 270° to 315°, and a Tom1 drum from 315° to 360° (or 0°).

It would be understood that in some embodiments the greater the sensitivity of the audio signal directional processing the greater the accuracy of drum simulation. For example in some embodiments the user interface converter can be configured to determine whether the ‘virtual drum’ has been hit in the centre or edge of the drum, in other words within the drum region there are sub-regions which when a ‘tap’ or other sound is detected causes the user interface output to output a parameter defining how close to the centre of the drum the hit is.

Thus in these embodiments the user interface converter 303 can be configured to generate a much better simulation of a drum.

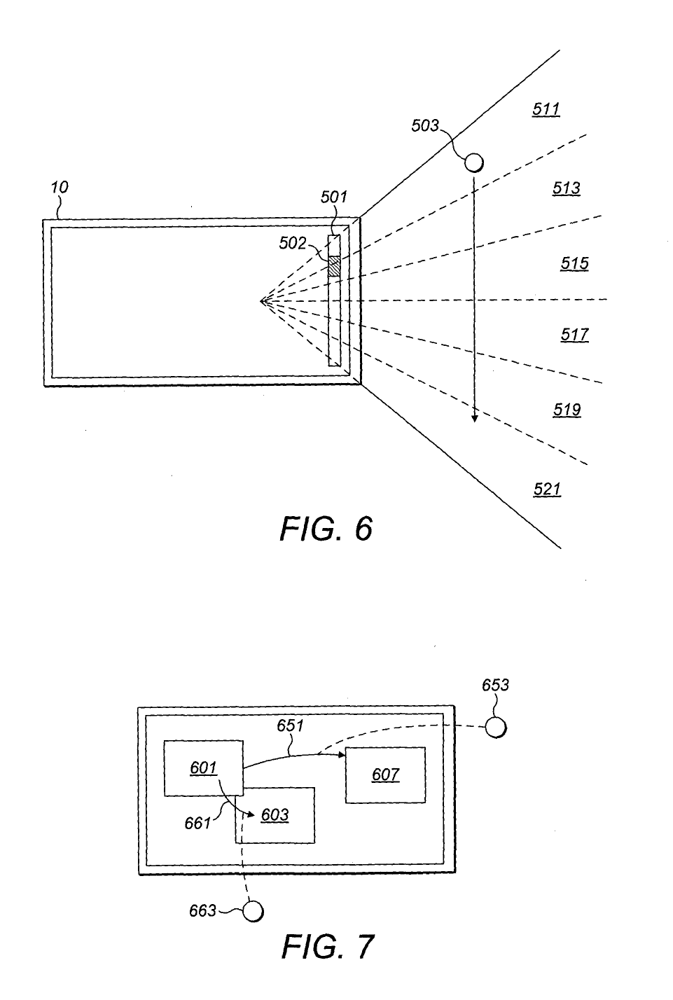

With respect to FIG. 6 the use of the apparatus in controlling a scrolling action for viewing documents and images is shown. It would be understood that due to the small screen size of the apparatus 10 documents or images have to be displayed in such a manner that to view the whole document a scrolling or panning action is required, however by requiring the user to touch the screen to perform the scrolling blocks at least a part of the image displayed.

In some embodiments the directional processor 201 and user interface converter 203 can be configured to control the scrolling action by monitoring a tapping or dragging noise of an object on a surface on which the apparatus is located.

Thus for example as shown in FIG. 6 there can be defined regions to one side of the apparatus (as shown in FIG. 6 on the right hand side of the display, but could in some embodiments be on the left hand side of the display) which represent scrolling locations down the document or image and a tap on the surface causes the document or image to move to that index or scrolling location. In the example shown in FIG. 6 the apparatus shows on the display a scrollbar 501 on which the current location of the displayed information is shown relative to the whole document or image.

In some embodiments the motion of the sound of the object (such as a finger, finger nail, pen or other suitable object on the surface) dragging is detected by the directional processor 201 and causes the user interface converter 203 to generate a scrolling user interface input in the direction of movement of the object.

This could be implemented according to some embodiments by the user interface converter 203 monitoring whether the sound occurs within a region or arc and identifying whether the sound moves up or down the regions. For example a ‘dragging’ sound of an object 503 on a surface which moves through the regions 511, 513, 515, 517, 519, and 521 which are regions arranged going down the right hand side of the apparatus could generate a ‘scrolling action downwards’ user interface input. It would be understood that a ‘scrolling action upwards’ interface input could be generated in such embodiments by dragging the object upwards.

Similarly in some embodiments regions above and/or below the apparatus could be defined and ‘scrolling action leftwards’ and ‘scrolling action rightwards’ user interface inputs generated by left and right moving object ‘dragging’ sounds respectively.

In some embodiments a multipage document can be paged into suitable sizes to be shown on the screen. In such embodiments a tap to the left or over the apparatus can be configured to generate a page back user input and a tap to the right or below the apparatus can be configured to generate a page forwards user input.

With respect to FIG. 7 a further example of a user interface input generation is shown with respect to windows or layer focus input. As modern devices can display many windows or layers of information on the display the selection or ‘focus selection’ operation where one of the windows is selected to be further interacted with is an important operation.

In some embodiments each of the windows or layers can be indexed and a ‘tap’ sound increments the selected index value, in other words selects the next window or layer. For example as shown in FIG. 7, where window 601 has an index value of 1, window 603 has an index value of 2, and window 607 has an index value of 3 a single tap can move the selected window from window 601, to window 603, to window 607.

However in some embodiments the location of the tap controls the index value motion. In other words a ‘tap’ sound to the right of the apparatus increments the index value and a ‘tap’ sound to the left of the apparatus decrements the index value.

In some embodiments the location of the tap moves the window selection in the direction of the ‘tap’ sound. For example if, as shown in FIG. 7, the current selected window is window 601 then then a ‘tap’ to the right (shown by object 653) moves (as shown by the arrow 651) the selection to window 607. Furthermore from window 601 a ‘tap’ to the bottom (shown by object 663) moves (as shown by the arrow 661) the selection to window 603.

Although in some embodiments a single tag is described it would be understood that a double or other multiple tap can be detected and used as a trigger by the user interface converter to generate the suitable user interface input signal.

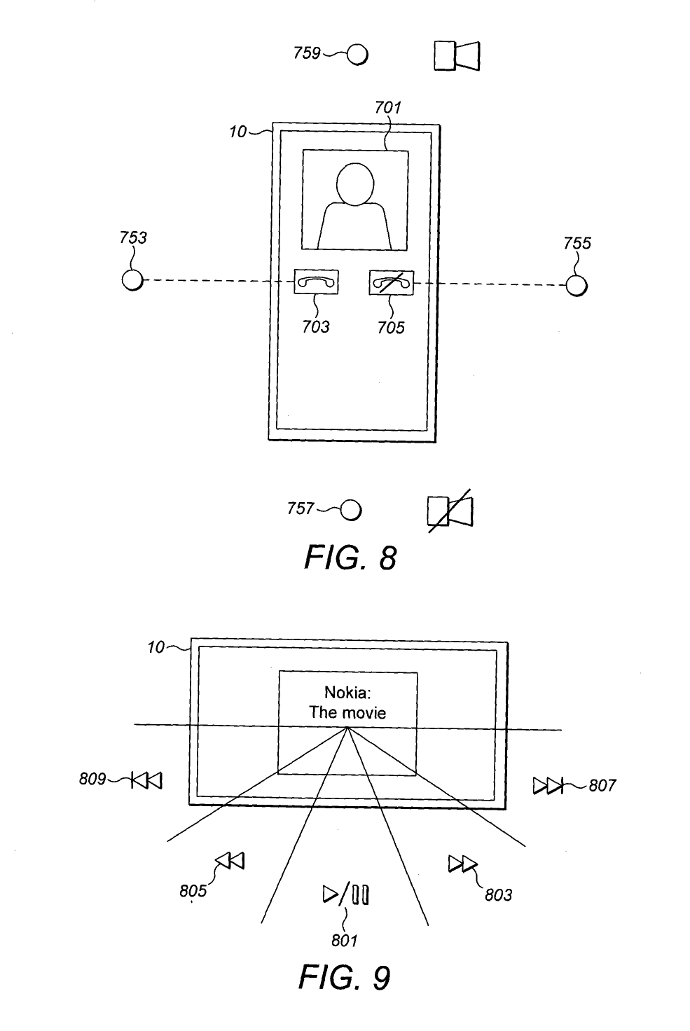

With respect to FIG. 8 a further example use case is shown where the directional processor 201 and user interface converter 203 are configured to supply a user interface selection signal dependent on the ‘tap’ sound location. In the example shown in FIG. 8 the apparatus 10 has an incoming call 701 displayed on the apparatus 10.

The conventional make/take call 703 and end call 705 user interface buttons are displayed to the left and right of the apparatus. However in some embodiments the make call function can be instigated by the user interface converter 203 generating a suitable signal based on detecting the user ‘tap’ sound on the surface to the side of the make call button 703. In other words the user can tap the surface to left of where the apparatus is lying at point 753 rather than use ‘virtual’ make call button 703 (it would be understood that in some embodiments the displayed ‘virtual’ button can be as small as required or even missing where the user understands the tap direction required). Similarly the end call function can be instigated by the detection of a user ‘tap’ to the right (for example point 755) of the display.

It would be understood that in some embodiments other functionality can be provided by determining ‘tap’ sounds around the apparatus. For example muting and unmuting can be performed by detecting ‘tap’ sounds above the phone 759 to unmute the telephone call or below the phone 757 to mute the call. In some embodiments the ‘tap’ can toggle on and off the function, for example a tap above the phone mutes/unmutes the call and a tap below the phone switches the call in and out of hands free mode.

With respect to FIG. 9 the use case of controlling media player functionality is shown. For example the apparatus 10 and in particular the user interface converter 203 can be configured to define regions surrounding the apparatus within which when the surface is tapped media playback functions are initiated.

Any suitable functionality can be implemented. For example a volume increase/decrease function can be generated in the same manner as described herein with respect to scrolling (an upwards dragging sound increasing the volume and a downwards dragging sound decreasing the volume).

Furthermore as shown in FIG. 9 the media functionality can include a play/pause function 801 associated with ‘tap’ sounds within a region beneath the display, a fast forward function 803 associated with ‘tap’ sounds within a region to the right of the play region, and a next track, chapter etc function 807 associated with ‘tap’ sounds within a region to the right of the fast forward region, a rewind function 805 associated with ‘tap’ sounds within a region to the left of the play/pause region, and a last track, chapter etc function associated with ‘tap’ sounds within a region to the left of the rewind function region.

As described herein in some embodiments the directional processor can be configured to determine where there are multiple or concurrent ‘taps’ or ‘dragging’. In such embodiments the user interface converter can generate ‘multitouch’ like user interface signals.

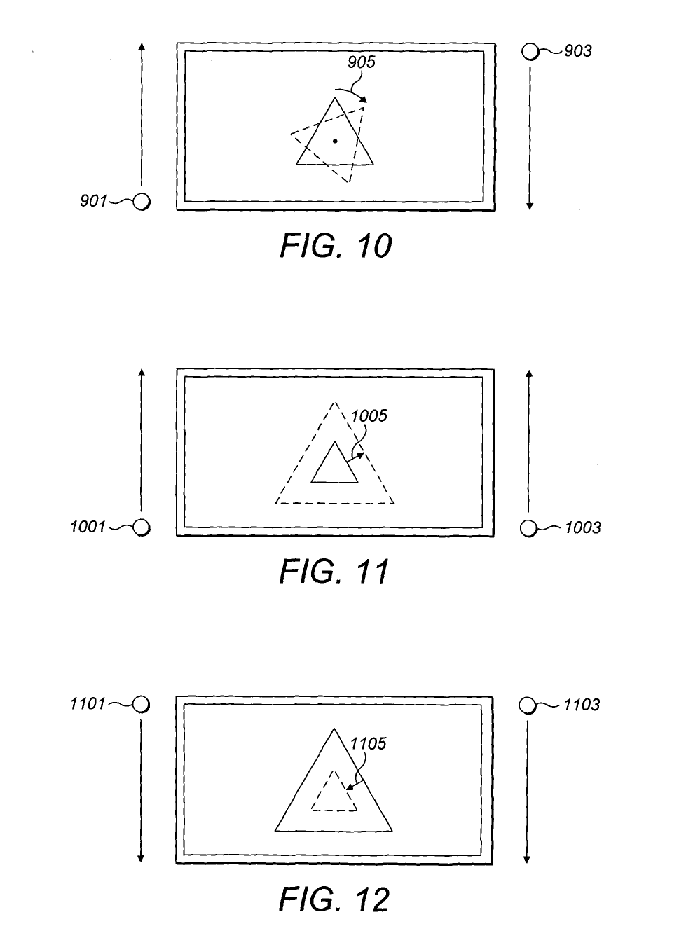

For example FIG. 10 shows an image rotation 905 function being performed based on a user interface signal output generated by detecting a first touch or dragging sound to the left 901 of the display moving upwards and a second touch or dragging sound to the right 903 of the display moving downwards and generating a rotation clockwise user interface signal. It would be understood that an anticlockwise rotation user interface signal could be generated after detecting a left touch moving downwards and a right touch moving upwards.

Furthermore in some embodiments a detecting similar contra-motion dragging action above and below the display region could also generate rotational user interface signals.

Furthermore with respect to FIGS. 11 and 12 a ‘multitouch’ type zooming in and zooming out user interface input is shown. Therefore in some embodiments an upwards moving dragging sound both to the left 1001 and to the right 1003 of the display can cause the user interface converter to generate a zooming in user interface signal as shown by the growth of the shape 1005 in FIG. 11. Similarly a downwards moving dragging sound both to the left 1101 and to the right 1103 of the display can cause the user interface converter to generate a zooming out user interface signal as shown by the growth of the shape 1105 in FIG. 12

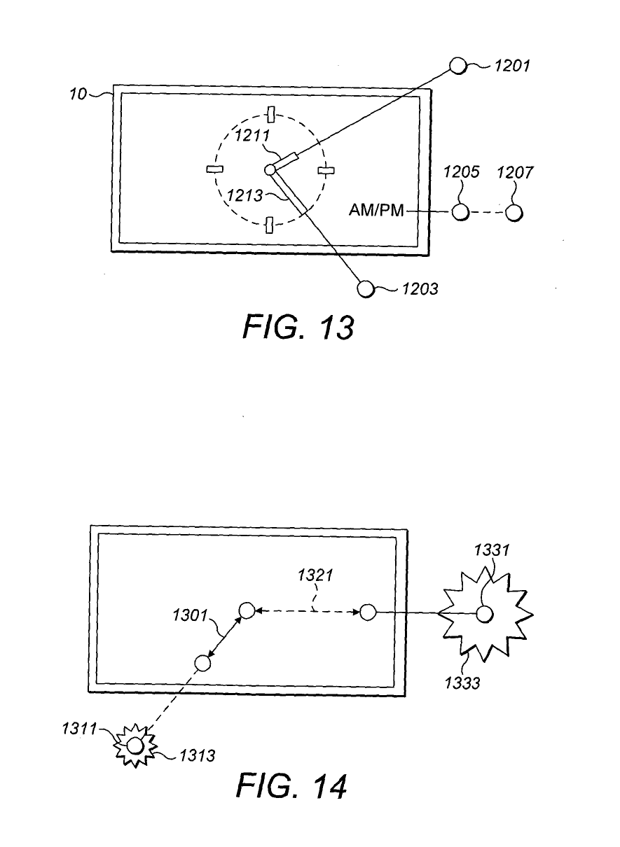

In some embodiments the user interface signal can be used to replace a user interface keypad or keyboard entry. For example as shown in FIG. 13 the direction of tapping can control specific applications such as setting an alarm clock function on the apparatus.

In such an example the setting of the hours, minutes of the alarm clock can be defined by tapping the apparatus resting surface at the approximate clock direction. For example a first touch 1201 direction defines the hour 1211 setting of the alarm clock, a second touch 1203 direction defines the minute 1213 setting of the alarm clock 1213 and a third tap or double tap defines whether the alarm is am. or p.m. (single tap 1205 being a.m. and a double tap 1207 being p.m.).

In some embodiments as shown herein subsequent inputs generated user inputs can depend on earlier or previous inputs. This is shown for example in the clock application shown in FIG. 13 where subsequent taps define hour, minute and am/pm settings. It would be understood that any suitable ‘memory’ or state based user input can be generated in a similar manner. For example a menu system can be navigated by a first tap selecting a first or entry level menu and subsequent taps or drags navigating the sub-menus or returning the apparatus state to the earlier menu level. For example an entry menu selection can be made by a tap to a defined region which then opens up sub menus associated with the entry menu which can either be navigated by further taps to progress down the menu structure or returned from by for example dragging the finger ‘backwards’ above or below the apparatus or ‘upwards’ to the left or right of the apparatus (or in some embodiments simply a tap to the left or top of the apparatus).

With respect to FIG. 14 a further example is shown where the sound user interface can be used to control the action of the apparatus when playing a game. In such embodiments the user interface converter 203 can be configured to generate multivariate inputs (for example a direction of firing and firing power in a shooting game) by determining a direction of a tap and a volume of a tap. For example as shown in FIG. 14 the user interface converter can generate a first direction, power user input for a first tap at location 1311 with a tap volume 1313 shown on the display with direction and distance 1301 a second direction, power user input for a second tap at location 1331 with a tap volume 1333 shown on the display with direction and distance 1321 (the second volume 1333 being greater than the first volume 1313 and thus the second distance 1321 being greater than the first distance 1301).

It would be understood that the user input could be any suitable gaming input such as controlling where a goalkeeper attempts to catch incoming balls by defining the direction the virtual goalkeeper dives by the direction of the tap. In such a way the device screen is not obstructed by the user's hands but the whole screen is visible to the user for the whole time while operating the application.

The user interface inputs could also be used for reaction time games and memory games requiring the user not to touch the screen and thus enable the screen to display the maximum amount of information without being obscured.

Furthermore elements of a public land mobile network (PLMN) may also comprise apparatus as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-23. (canceled)

24. An apparatus comprising:
an input configured to receive at least one detected acoustic signal from one or more sound sources;
a sound direction determiner configured to determine one or more directions associated with the one or more sound sources based on the detected at least one acoustic signal; and
a user interface input generator configured to generate at least one user interface input based on the one or more directions, wherein the user interface input is configured to control the apparatus operation.

25. The apparatus as claimed in claim 24, further comprising a display module configured to display at least one received information of the at least one user interface input.

26. The apparatus as claimed in claim 24, further comprising two or more microphones configured to detect at least one acoustic signal from one or more sound sources.

27. The apparatus as claimed in claim 26, wherein the sound direction determiner is configured to determine the one or more directions associated with the one or more sound sources based on the detected at least one acoustic signal relative to the apparatus.

28. The apparatus as claimed in claim 24, wherein the input configured to receive at least one detected acoustic signal comprises at least a first audio signal input from a first microphone and at least a second audio signal input from a second microphone.

29. The apparatus as claimed in claim 28, wherein the sound direction determiner is configured to:
identify at least one common audio signal component within the at least one first audio signal and the at least one second audio signal;
determine a difference between the at least one common component such that the difference defines the one or more directions.

30. The apparatus as claimed in claim 24, further comprising a sound amplitude determiner configured to determine at least one sound amplitude associated with the one or more sound sources; and the user interface input generator configured to generate the at least one user interface input based on the one or more amplitude associated with the one or more sound sources, such that the one or more amplitude associated with the one or more sound sources is configured to control the apparatus operation.

31. The apparatus as claimed in claim 24, further comprising a sound motion determiner configured to determine at least one sound motion associated with the one or more sound sources; and the user interface input generator is further configured to generate at least one user interface input based on the one or more sound motion associated with the one or more sound sources, such that the one or more motion associated with the one or more sound sources is configured to control the apparatus operation.

32. The apparatus as claimed in claim 31, wherein the sound motion determiner is configured to:
determine at least one sound source direction at a first time;
determine at least one sound source at a second time after the first time; and
determine the difference between the at least one sound source direction at a first time and the at least one sound source at a second time.

33. The apparatus as claimed in claim 24, wherein the one or more sound sources comprises at least one of:
an impact sound on a surface on which the apparatus is located;
a contact sound on a surface on which the apparatus is located;
a ‘tap’ sound on a surface on which the apparatus is located; and
a ‘dragging’ sound on a surface on which the apparatus is located.

34. The apparatus as claimed in claim 24, wherein the user interface input generator comprises:
a region definer configured to define at least one region comprising a range of directions; and
an region user input generator configured to generate a user interface input based on the at least one direction associated with the one or more sound sources being within the at least one region.

35. The apparatus as claimed in claim 34, wherein the region definer is configured to define at least two regions, each region comprising a range of directions, and the region user input generator is configured to generate a first user interface input based on a first of the at least one direction being within a first of the at least two regions and generate a second user interface input based on the a second of the at least one direction being within a second of the at least two regions.

36. The apparatus as claimed in claim 35, wherein the at least two regions comprise at least one of:
the first region range of directions and second region range of directions at least partially overlapping;
the first region range of directions and second region range of directions adjoining; and
the first region range of directions and second region range of directions being separate.

37. The apparatus as claimed in claim 24, wherein the user input generator is configured to generate at least one of:
a drum simulator input;
a visual interface input;
a scrolling input;
a panning input;
a focus selection input;
a user interface button simulation input;
a make call input;
a end call input;
a mute call input;
a handsfree operation input;
a volume control input;
a media control input;
a multitouch simulation input;
a rotate display element input;
a zoom display element input;
a clock setting input; and
a game user interface input.

38. The apparatus as claimed in claim 24, wherein the sound direction determiner is configured to determine a first direction associated with a first sound source and determine a second direction associated with a second sound source, and wherein the user interface input generator is configured to generate the user interface input based on the first direction and the second direction.

39. The apparatus as claimed in claim 38, wherein the sound direction determiner is configured to determine the first direction associated with the first sound source over a first range of directions and determine the second direction associated with the second sound source over a second separate range of directions, and the user interface input generator is configured to generate a simulated multi-touch user interface input based on the first and second directions.

40. The apparatus as claimed in claim 38, wherein the sound direction determiner is configured to determine the first direction associated with the first sound source and determine the second direction associated with the second sound source subsequent to the first sound source, and the user interface input generator is configured to generate a first of the user interface inputs based on the first direction, and a second of the user interface inputs based on the second direction and conditional on the first direction.

41. An apparatus comprising at least one processor and at least one memory including computer code for one or more programs, the at least one memory and the computer code configured to with the at least one processor cause the apparatus at least to:
receive at least one detected acoustic signal from one or more sound sources;
determine one or more directions associated with the one or more sound sources based on the detected at least one acoustic signal; and
generate at least one user interface input based on the one or more directions, wherein the user interface input is configured to control the apparatus operation.

42. The apparatus as claimed in claim 41, is further caused to determine at least one sound amplitude associated with the one or more sound sources; and the generated at least one user interface input is based on the at least one sound amplitude, such that the at least one sound amplitude is configured to control the apparatus operation.

43. A method comprising:
receiving at least one detected acoustic signal from one or more sound sources;
determining one or more directions associated with the one or more sound sources based on the detected at least one acoustic signal; and
generating at least one user interface input based on the one or more directions, wherein the user interface input is configured to control the apparatus operation.
